(19) United States
(12) Patent Application Publication
(10) Pub. No.: US 2025/0027277 A1
(43) Pub. Date: Jan. 23, 2025

(54) Apparatus for Releasably Connecting Panels Together

(71) Applicant: Fergus Jonathan Ardern, Lingwood (GB)

(72) Inventor: Fergus Jonathan Ardern, Lingwood (GB)

(21) Appl. No.: 18/758,659

(22) Filed: Jun. 28, 2024

(30) Foreign Application Priority Data
Jun. 29, 2023 (GB) GB2309885.8

(51) Int. Cl. E01C 5/00

(52) U.S. Cl. CPC E01C 5/005

(57) ABSTRACT

Apparatus or a kit of parts are disclosed for releasably connecting panels together, the apparatus comprising an upper part, a lower part and a connection member. The upper part has an upper surface and two side walls arranged substantially in parallel with one another and each substantially perpendicularly from the upper surface, and wherein the upper surface has a substantially circular aperture formed within it, and a substantially cylindrical wall extends downwards from the circular aperture substantially parallel to the two side walls, and wherein at least one stop is arranged within the cylindrical wall, the stop having an abutment surface for engagement with an abutment surface of a connection member. The lower part comprises a connection member engagement surface having an opening adapted to allow a lower end of the connection member to pass through the opening when the connection member is in a particular rotational orientation and to engage with the lower end of the connection member when the connection member is in another particular rotational orientation. The connection member comprises a substantially cylindrical shaft having a main shaft portion, an upper end and a lower end, and wherein the upper end is of larger diameter than the main shaft portion, and wherein the lower end is of the same diameter as the main shaft and comprises at least one wing portion, the wing portion extending radially from the lower end of the shaft and having an abutment surface for engagement with an abutment surface of a stop of the upper part, and wherein the connection member comprises a helical spring wound around the shaft, the spring being held in place by the upper end of the connection member and the or each wing portion.

### FIELD OF THE INVENTION

The present invention relates to a releasable connection apparatus for connecting neighbouring surface-covering panels to form a planar floor array. The connection means acts to increase the resistance towards separation of conjoined panels.

### BACKGROUND TO THE INVENTION

Surface panels are widely used both to protect a surface and also to enable a surface to be used for a purpose for which it would otherwise be unsuitable. Typically, a plurality of panels is assembled together into a planar array. The planar array then provides a surface on which people or vehicles can move. As examples of uses to which such an array can be put, can be cited for use as a roadway or for taxiing aircraft. Also, the pitch in a sports stadium or the like can be converted into an arena for a concert so that the turf is not damaged.

An important feature of an array of panels is the connection means between individual panels.

A challenge with panel arrays is dealing with transient loads—i.e. moving loads—especially when a load moves from one panel to another.

Attempts have been made to address this challenge, for example by making a joint between panels wider to spread the load. The present invention proposes a new approach.

### SUMMARY OF INVENTION

The present invention provides apparatus for releasably connecting panels together, the apparatus comprising an upper part, a lower part and a connection member.

The skilled reader will appreciate that the terms upper and lower are used to identify relative orientation etc. between elements of the apparatus but the language used is not intended to imply a specific orientation in use.

In practice, the upper part may form part of a panel and the lower part may form part of another panel. A panel suitable to form a panel array may have at least one upper part to connect to another panel and at least one lower part to connect to another panel. The upper part, lower part and connection member may thus be provided separately and combined in use or provided as a kit of parts.

The upper part has an upper surface and two side walls arranged substantially in parallel with one another and each substantially perpendicularly from the upper surface—downwards in the described relative orientation. The upper surface has a substantially circular aperture formed within it, and a substantially cylindrical wall extends downwards from the circular aperture substantially parallel to the two side walls. One or more optional braces can extend between a side wall and the cylindrical wall to provide further strength and stability. At least one stop is arranged within the cylindrical wall, the stop having an abutment surface for engagement with an abutment surface of a connection member. There may be four stops approximately equally spaced around and within the cylindrical wall with gaps between them; providing four abutment surfaces with gaps between them. The gaps provide a non-abutment space for insertion or removal of said connection member in use.

Two stops may be joined by a bridge arranged between them, the bridge having a further abutment surface arranged at an offset to the abutment surfaces of the stops joined by the bridge. The further abutment surface of the bridge provides for engagement with an abutment surface of a connection member. The offset arrangement of an abutment surface of a stop and a further abutment surface of a bridge provides for at least two positions in which a connection member can engage within the cylindrical wall without being removed from the upper part. This provides for a captive connection member arrangement, enabling the upper and lower part to be disconnected from one another without requiring the removal of the connection member. This is useful to prevent the connection member from being lost outside the apparatus when the upper and lower part are disconnected—for example when panels are being transported or stored.

The cylindrical wall may have regions of different internal diameter. At a transition between two regions of different internal diameter a lip may be formed within the cylindrical wall. Such a lip can provide a barrier to prevent a corresponding portion of a connection member from passing further down through the cylindrical wall in use. This can prevent the connection member from being lost within the apparatus.

The upper surface of the upper part is preferably substantially perpendicular to each of the side walls of the upper part. The side walls may not be precisely the same height as one another.

Lower edges of the cylindrical wall, one of the side walls and any braces may be aligned to and conform with a lower edge plane which forms an angle to the upper surface. A lower edge of the other side wall may not be so aligned and conform with the said lower edge plane. Thus lower edges of the cylindrical wall, one of the side walls and any braces can form a slope, and the other side wall can form a lip with respect to that slope.

In other words, a lower edge of the cylindrical wall and that of any braces can be angled to match the lower edge plane.

More than one cylindrical wall, as described, may be provided in the apparatus. The apparatus may form part of a panel. Alternatively or in addition, a panel may be provided with a plurality of upper parts each having a cylindrical wall as described.

The lower part may further comprise a connection member engagement surface having an opening adapted to allow a lower end of the connection member to pass through the opening when the connection member is in a particular rotational orientation and to engage with the lower end of the connection member when the connection member is in another particular rotational orientation. In other words, the lower end of the connection member can pass through the opening in the connection member engagement surface when the connection member is in one position but not when the connection member is in another position. In use, the connection member can be inserted and removed when it is in one rotational orientation but not when in another. Thus, the connection member can be inserted then rotated to another orientation so that it cannot be removed.

The connection member engagement surface may be arranged approximately parallel to the lower surface of the lower part near or at an upper end of the side walls of the lower part.

The opening of connection member engagement surface of the lower part may have an approximately circular shape with at least one wider portion adapted to allow passage of a wing of the connection member. In a portion of the opening which does not have a wider portion, said wing of the connection member would not be able to pass through the opening—thus providing optional locking and release orientations of the connection member. The wider portion may be rectangular.

The connection member engagement surface of the lower part may be provided on a removable insert. The removable insert may have an upper surface comprising said connection member engagement surface and a substantially vertical insert side wall adapted to fit inside the box of the lower part. The insert side wall may thus be substantially rectangular in cross section. The insert side wall may have portions of different length in the dimension which is in parallel to the side wall of the lower part in use. In other words, the insert side wall may be stepped in at least one dimension. The insert side wall may have one or more engagement surfaces, adapted to engage one or more corresponding engagement surfaces of the box. The insert may further comprise one or more tabs sized and located to engage with corresponding openings of the box. Thus, in use, the insert can be removably inserted into the box of the lower part and removably attached thereto by the tabs/opening arrangement as described.

Provision of the connection member engagement surface of the lower part on a removable insert facilitates maintenance of the lower part—for example by replacement of the insert without the need to replace the whole lower part.

The insert may be open at a lower end thereof. The lower end of the insert may be adapted to engage with or otherwise receive a part of a lower part cover. The lower part cover may be provided with a friction fit engagement means, sized and shaped to form a friction fit with the insert.

Thus, said opening in the lower surface approximately co-located with a lower region of the box wall can accept the insert and the lower part cover can close the said opening and hold the insert in place in use. The lower part cover can have a lower surface, which is flush with the lower surface of the lower part in use.

The lower surface of the lower part is preferably substantially perpendicular to each.

The connection member engagement surface, whether provided integral with the box wall or as part of an insert, may be parallel to the lower surface of the lower part.

More than one box, as described, may be provided in the apparatus. Alternatively, a panel may be provided with a plurality of lower parts each having a box as described.

The connection member comprises a substantially cylindrical shaft having a main shaft portion, an upper end and a lower end. The upper end is of larger diameter than the main shaft portion. The lower end is of the same diameter as the main shaft and comprises at least one wing portion, the wing portion extending radially from the lower end of the shaft and having an abutment surface for engagement with an abutment surface of a stop of the upper part. The connection member may have two wing portions which extend radially in substantially opposite directions from each other. The connection member may have more wing portions, arranged substantially equally spaced around the shaft. The or each wing may be located at the end of the main shaft.

The connection member comprises a helical spring wound around the shaft, the spring being held in place by the upper end of the connection member and the or each wing portion. In use, the spring can engage with a lip of the upper part so that a downward force on the connection member into the upper part compresses the spring and in turn urges the connection member upwards. This action provides for an abutment force between the or each wing of the connection member and a corresponding abutment surface of the upper part. Furthermore, this action provides for easier removal of the connection member when needed.

The main shaft of the connection member is preferably long enough so that the one or more wings can engage with a corresponding connection member engagement surface of the lower part and exert an abutment force thereon. This allows the connection member to hold the upper and lower parts together when needed.

The upper end of the connection member can have a pattern of indentations formed within it, which are designed to be engaged by a suitable tool with corresponding protrusions.

In use, the upper part and the lower part may be locked together by one or more connection members. When thus locked together, the upper part is preferably located substantially above the lower part.

With respect to the upper part, lower edges of the cylindrical wall, one of the side walls and braces may be aligned to and conform with a lower edge plane which may form an angle to the upper surface. A lower edge of the other side wall may not be so aligned and in conformance with the said lower edge plane. Thus lower edges of the cylindrical wall, one of the side walls and braces can form a slope, and the other side wall can form a lip with respect to that slope.

With respect to the lower part, upper edges of the box wall, one of the side walls and spacers may be aligned to and conform with an upper edge plane which may form an angle to the lower surface. An upper edge of the other side wall may not be so aligned and in conformance with the said upper edge plane. Thus upper edges of the box wall, one of the side walls and spacers can form a slope, and the other side wall can form a lip with respect to that slope.

The upper part and the lower part can thus engage with one another with the lower edge plane of the upper part matching the upper edge plane of the lower part so that the upper part can sit atop the lower part with the upper surface of the upper part substantially parallel to the lower surface of the lower part. One of the side walls of the lower part can rest against a lip formed by one of the side walls of the upper part, and the upper edge plane of the lower part. The other side wall of the lower part can rest against the lip formed by said side wall of the lower part and the upper edge plane of the lower part.

Thus, the upper part side walls extend down from the upper surface and, when locked, can be slightly offset from the lower part side walls—which extend up from the lower surface.

In use, one or more connection members may be located within the circular aperture of the upper part and the one or more connection members extend downwards within the cylindrical wall. This forms a captive connection member arrangement described. In this arrangement, the wings of the connection member are located against the abutment surfaces of the upper part.

To insert a connection member downwards into the apparatus so that the lower end of the connection member can engage the lower part, the connection member wings can be aligned with the wider openings of the of the lower part (for example formed as an insert). A downward force can overcome bias of the spring to insert the connection member. To lock a connection member in position, so as to connect the upper part and lower part together, the connection member can be rotated so that wings of the connection member are no longer aligned with the wider openings of the lower part. The bias of the spring urges the wings upwards so that abutment surfaces of the wings of the connection member abut corresponding abutment surfaces of the insert of the lower part.

When in the locked position the upper end of the connection member may sit flush against the upper surface of the upper part.

To unlock a connection member, so as to disconnect the upper part and lower part from one another, the connection member can be rotated so that wings of the connection member are aligned with the wider openings of the lower part. Then, the connection member can be withdrawn from the lower part. The arrangement of the cylindrical wall as described provides for a connection member to be not fully removed from the upper part, i.e. kept captive, if needed.

### DETAILED DESCRIPTION OF THE INVENTION

An exemplary embodiment of elements of the present invention will now be described with reference to the accompanying drawings in which:

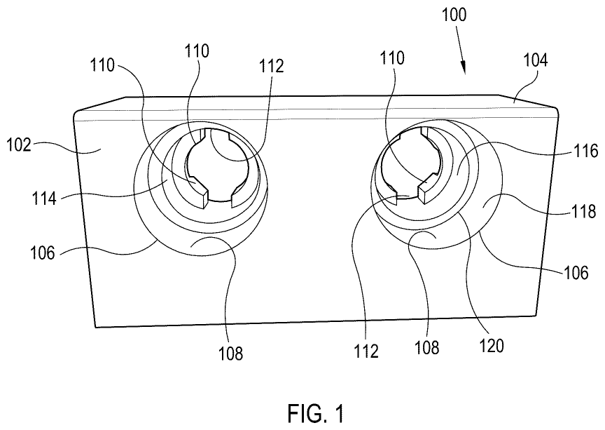

FIG. 1 shows a perspective view of the upper part of the apparatus, facing towards the upper side of the upper surface;

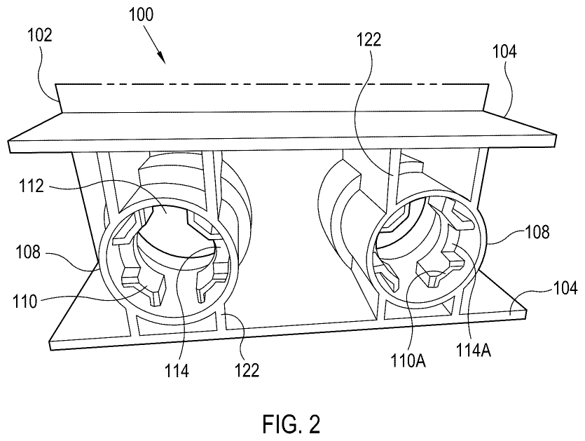

FIG. 2 shows the same upper part as shown in FIG. 1, in perspective view, facing underneath the upper part;

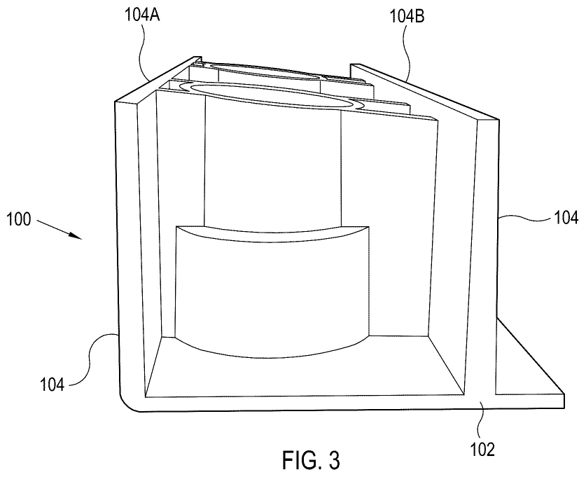

FIG. 3 shows the same upper part as shown in FIGS. 1 and 2, in side elevation from one end;

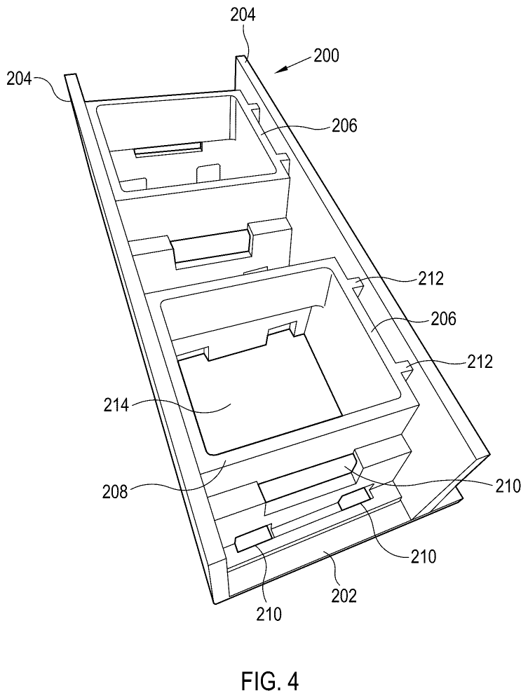

FIG. 4 shows a perspective view of the lower part of the apparatus, as seen from above the lower part, the lower part being shown without an insert;

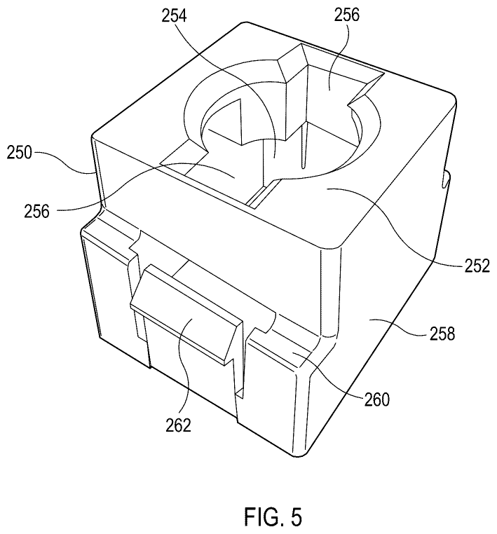

FIG. 5 shows a perspective view of an insert for use with the lower part as shown in FIG. 3;

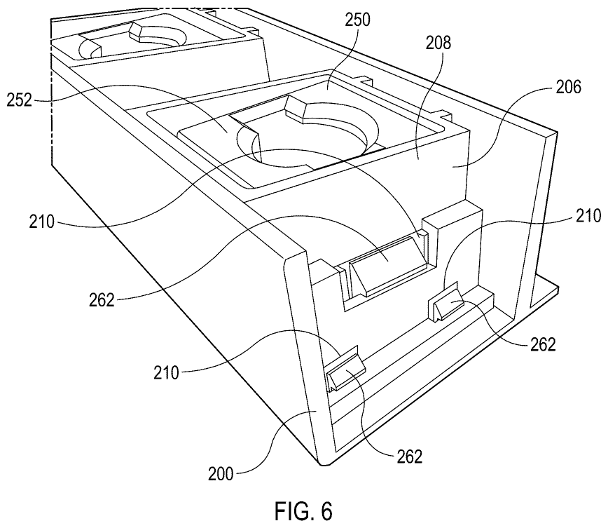

FIG. 6 shows a perspective view of the same lower part as shown in FIG. 4, with the insert shown in FIG. 5 in place for use;

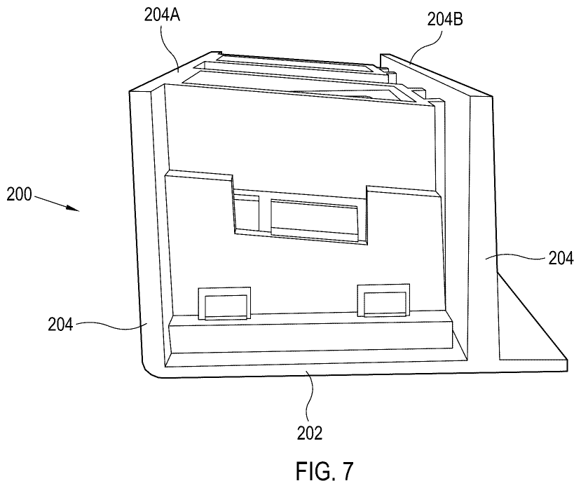

FIG. 7 shows the same lower part and insert as shown in FIG. 6, in side elevation from one end;

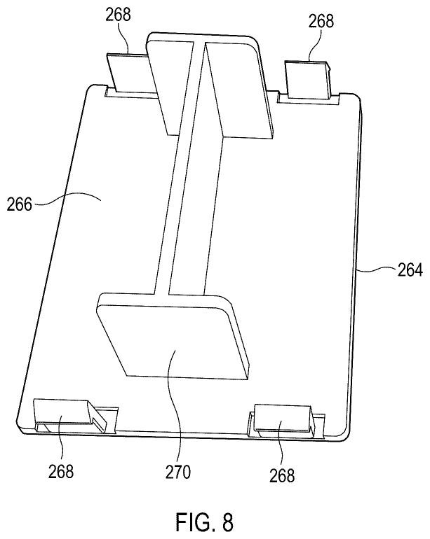

FIG. 8 shows a perspective view of a lower part cover for use with the lower part as shown and described;

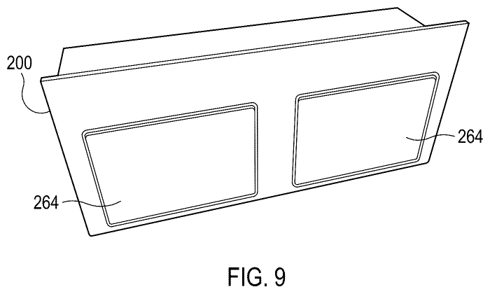

FIG. 9 shows a perspective view of the lower part of the apparatus, facing towards the lower side of the lower surface;

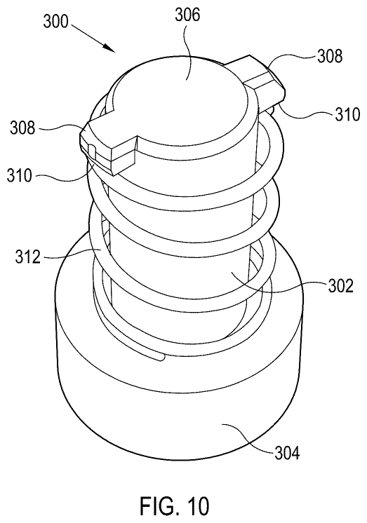

FIG. 10 shows a perspective view of the connection member of the apparatus from a lower end thereof;

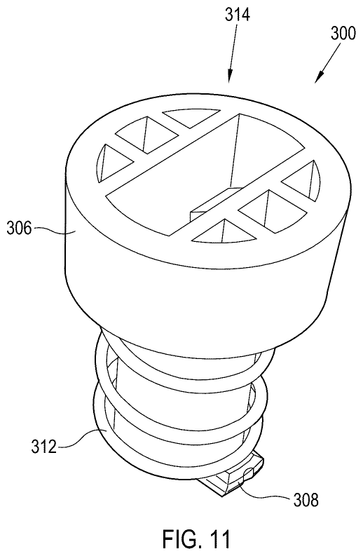

FIG. 11 shows a perspective view of the same connection member as shown in FIG. 10, from an upper end thereof; and

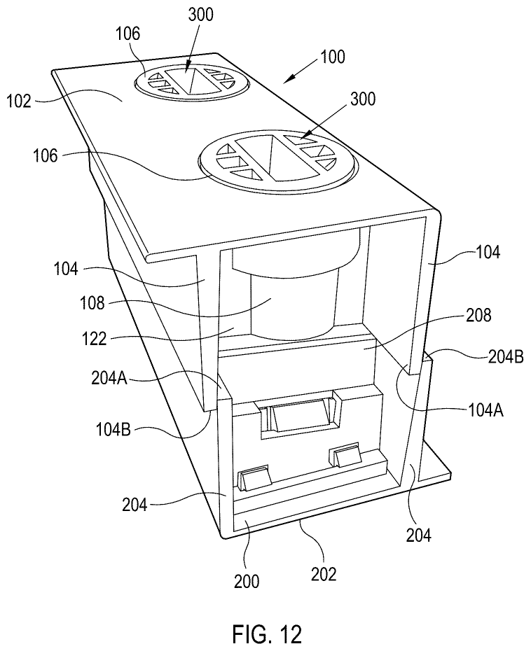

FIG. 12 shows a perspective view of the apparatus with the upper and lower parts locked together by connection members, being as shown in FIGS. 10 and 11.

In the drawings, not all features shown and described are labelled in every instance, for the purpose of aiding clarity of the drawings. The skilled reader will appreciate that unlabelled features are nonetheless present in the elements of the exemplary embodiment.

In FIG. 1, upper part 100 has an upper surface 102 and two side walls 104, with the side walls 104 being parallel with one another and perpendicular to the upper surface 102. The upper surface 102 has two circular apertures 106 formed within it. A cylindrical wall 108 extends from each circular aperture 106, parallel to the side walls 104—downwards in the terminology used throughout this description. Stops 110 are arranged within each cylindrical wall 108 and the stops 110 provide an abutment surface for engagement with a corresponding abutment surface of a connection member (described separately). Between the stops 110 are provided gaps 112 through which portions of the said connection member can pass for insertion or removal thereof. Thus, a connection member can be inserted or removed from the cylindrical wall 108 and rotated so that it is selectively stopped or not stopped within the cylindrical wall 108.

Bridges 114 can join selected pairs of stops 110 to provide a further abutment surface arranged at an offset to the abutment surfaces of the stops 110 which are joined by the bridge 114.

The offset arrangement of an abutment surface of a stop 110 and a further abutment surface of a bridge 114 provides for at least two positions in which a connection member can engage within the cylindrical wall 108 without being removed from the upper part 100. This provides for a captive connection member arrangement, enabling the upper and lower part of the apparatus to be disconnected from one another without requiring the removal of the connection member. This is useful to prevent the connection member from being lost outside the apparatus when the upper and lower part are disconnected—for example when panels are being transported or stored.

The cylindrical wall 108 has regions of different internal diameter. A lower region 116 has a smaller internal diameter than an upper region 118. In each instance in this embodiment, the lower region 116 and the upper region 118 have uniform respective internal diameters. At a transition between the regions of different internal diameter a lip 120 is formed within the cylindrical wall 108. The lip 120 can provide a barrier to prevent a corresponding portion of a connection member from passing further down through the cylindrical wall 108 in use. This can prevent the connection member from being lost within the apparatus.

FIG. 2 shows the upper part 100 from its underside, or below the upper surface 102. Side walls 104 extend downwards from the upper surface 102. Cylindrical walls 108 extend downwards from circular apertures 106. Within the cylindrical walls 108 are stops 110 with either gaps 112 or bridges 114 arranged between the stops 110. The stops 110 have abutment surfaces 110A on their undersides. The bridges 114 have abutments surfaces 114A on their undersides. The abutment surfaces 110A and 114A are offset within the cylindrical wall 108.

Braces 122 extend between a side wall 104 and the cylindrical wall 108.

The side walls 104 are of slightly different height from one another, so that a plane joining lower edges of the respective side walls 104 would not be parallel to the upper surface 102. This is best shown in FIG. 3.

In FIG. 3, the same upper part 100 is shown with the upper surface 102 facing downwards. The side walls 104 are of slightly different height to one another, which can be clearly seen when the upper part 100 is shown in this orientation. Lower edges of the cylindrical wall, one of the side walls 104A and braces are aligned to and conform with a lower edge plane which forms an angle to the upper surface 102. A lower edge of the other side wall 104B is not so aligned and in conformance with the said lower edge plane. Thus lower edges of the cylindrical wall, one of the side walls 104A and braces form a slope, and the other side wall 104B forms a lip with respect to that slope.

In use, the upper part 100 could be formed as part of a panel.

In FIG. 4, a lower part 200 has a lower surface 202 and two side walls 204 extending perpendicularly upwards from the lower surface 202 and parallel to one another. Extending between the side walls 204 are arranged two boxes 206, each box 206 having a box wall 208 which has a generally rectangular cross section, with portions of the box wall 208 being parallel to the side walls 204 and portions of the box wall 208 being perpendicular to the side walls 204. Each box 206 has portions of different cross section, with three different lengths of box wall 208 parallel to the side walls 204. Said lengths are longest where the box wall 208 is at the lower surface 202 of the lower part 200, of intermediate length in the adjacent portion and of shortest length in the portion nearest an upper part of the side walls 204. This forms a kind of stepper or ziggurat profile for the box wall 208. At transitions between portions of different lengths, openings 210 in the box wall 208 can accommodate and engage corresponding tabs of an insert (not shown in FIG. 4). In this exemplary embodiment, the boxes 206 are attached directly to one of the side walls 204 and to the other side wall 204 by way of a pair of spacers 212.

The lower part 200 has openings 214 in the lower surface 202, the openings 214 being co-located with a lower portion of the box walls 208.

The upper edge of the box wall 208 is flush with the upper edge of the corresponding side wall 204.

FIG. 5 shows an insert 250 having an upper surface having a connection member engagement surface 252 which has an opening 254 having a circular shape with two wider portions 256 to allow passage of wings of the connection member through the opening 254. Thus, wings of the connection member can pass through the opening 254 in one orientation but not in others. The said wings of the connection member can therefore be passed through the opening then the connection member rotated so that they cannot pass back through the opening. The connection member can thus be held in position.

The insert 250 has a vertical insert side wall 258 sized to fit inside a box of the lower part. The insert side wall 258 has approximately a rectangular cross section. The insert side wall 258 has portions of different length in the dimension parallel to the side wall of the lower part in use. In other words, the insert side wall 258 is stepped in at least one dimension. At a transition 260 between portions of different length the insert side wall 258 forms an engagement surface, which is adapted to engage one or more corresponding engagement surfaces of the box of the lower part. The insert side wall 258 can also have one or more tabs 262 in the region of the transition 260. Tabs can engage with corresponding openings of the box of the lower part.

Thus, in use, the insert 250 can be removably inserted into the box of the lower part and removably attached thereto by the tabs/opening arrangement as described.

The insert 250 is open at a lower end thereof (not directly shown in FIG. 5). The lower end of the insert 250 is adapted to engage with or otherwise receive a part of a lower part cover.

In FIG. 6, the lower part 200 has the insert 250 positioned within the box 206 of the lower part 200. The insert 250 is removably held within the box 206 by the tabs 262 of the insert 250 engaging with corresponding openings 210 in the box wall 208 of the box 206. Thus, the connection member engagement surface 252 is held in place in use and can be removed by removing the insert 250; this is useful for replacing components over time.

In FIG. 7, the lower part 200 is shown with the lower surface 202 facing downwards.

Upper edges of the box wall, one of the side walls 204A and spacers are aligned to and conform with an upper edge plane which forms an angle to the lower surface 202. An upper edge of the other side wall 204B is not so aligned and in conformance with the said upper edge plane. Thus upper edges of the box wall 208, one of the side walls 204A and spacers form a slope, and the other side wall 204B forms a lip with respect to that slope.

The side walls 204 are of slightly different height to one another, which can be clearly seen in this drawing.

FIG. 8 shows a lower part cover 264 having a lower surface 266 from which upstand tabs 268 which are adapted to engage with corresponding openings of the insert or box of the lower part. From the lower surface 266 of the lower part cover 264 also upstands a friction fit wall 270 adapted to engage with corresponding parts of the box of the lower part or the insert.

FIG. 9 shows the underside of the lower part 200 of the apparatus. Two lower part covers 264 are shown, closing openings within the lower part 200, with a flush surface.

FIG. 10 shows a connection member 300 which has a cylindrical shaft having a main shaft portion 302, an upper end 304 and a lower end 306. The upper end 304 is of larger diameter than the main shaft portion 302. The lower end 306 is of the same diameter as the main shaft portion 302 and has two wing portions 308 extending radially from the lower end 306 of the cylindrical shaft. The wing portions 308 each has an abutment surface 310 on an upper side of the wing portions 308. The abutment surfaces 310 are adapted to engage with corresponding abutment surfaces on the upper and lower parts of the apparatus. The connection member 300 has a helical spring 312 wound around the shaft, the spring 312 being held in place by the upper end 304 of the connection member 300 and the wing portions 308 at the lower end 306. In use, the spring 312 can engage with a lip of the upper part so that a downward force on the connection member 300 into the upper part compresses the spring 312 and in turn urges the connection member 300 upwards.

FIG. 11 shows the same connection member 300. The upper end 306 has a pattern of indentations 314 formed within it, which are designed to be engaged by a suitable tool with corresponding protrusions. The pattern of indentations 314 has a larger central indentation with a generally rectangular shape and along the long sides of the generally rectangular central indentation three smaller indentations are formed.

FIG. 12 shows an end perspective view of the exemplary upper part 100 and the exemplary lower part 200 locked together by two exemplary connection members 300. When thus locked together, the upper part 100 is located substantially above the lower part 200.

With respect to the upper part 100, lower edges of the cylindrical wall 108, one of the side walls 104A and braces 122 are aligned to and conform with a lower edge plane which forms an angle to the upper surface 102. A lower edge of the other side wall 104B is not so aligned and in conformance with the said lower edge plane. Thus lower edges of the cylindrical wall 108, one of the side walls 104A and braces 122 form a slope, and the other side wall 104B forms a lip with respect to that slope.

With respect to the lower part 200, upper edges of the box wall 208, one of the side walls 204A and spacers are aligned to and conform with an upper edge plane which forms an angle to the lower surface 202. An upper edge of the other side wall 204B is not so aligned and in conformance with the said upper edge plane. Thus upper edges of the box wall 208, one of the side walls 204A and spacers form a slope, and the other side wall 204B forms a lip with respect to that slope.

The upper part 100 and the lower part 200 thus engage with one another with the lower edge plane of the upper part 100 matching the upper edge plane of the lower part 200 so that the upper part 100 can sit atop the lower part 200 with the upper surface 102 of the upper part 100 substantially parallel to the lower surface 202 of the lower part 200. Side wall 104A rests against the lip formed by side wall 204B and the upper edge plane of the lower part 100. Side wall 204A rests against the lip formed by side wall 104B and the upper edge plane of the lower part 100.

Thus, the upper part side walls 104 extend down from the upper surface 102 and, when locked, are slightly offset from the lower part side walls 204 which extend up from the lower surface 202.

In use, as shown in FIG. 12, the connection members 300 are located within the circular aperture 106 of the upper part 100 and the connection members 300 extend downwards within the cylindrical wall 108. This forms a captive connection member arrangement described. In this arrangement, the wings of the connection member are located against the abutment surfaces of the upper part 100.

To insert a connection member 300 downwards into the apparatus so that the lower end of the connection member can engage the lower part 200, the connection member wings should be aligned with the wider openings of the insert of the lower part 200. A downward force can overcome bias of the spring to insert the connection member 300. To lock the connection member 300 in position, so as to connect the upper part 100 and lower part 200 together, the connection member 300 should be rotated so that the wings of the connection member are no longer aligned with the wider openings of the insert of the lower part 200. The bias of the spring urges the wings upwards so that abutment surfaces of the wings of the connection member abut corresponding abutment surfaces of the connection member engagement surface of the insert of the lower part 200.

When in the locked position the upper end 304 of the connection member 300 sits flush against the upper surface 102.

To unlock the connection member 300, so as to disconnect the upper part 100 and lower part 200 from one another, the connection member should be rotated so that the wings of the connection member 300 are aligned with the wider openings of the insert of the lower part 200. Then, the connection member 300 can be withdrawn from the lower part 200. The arrangement of the cylindrical wall 108 as described provides for the connection member 300 to be not fully removed from the upper part 100, i.e. kept captive, if needed.

I claim:

1. An apparatus or kit for releasably connecting panels together, the apparatus comprising an upper part, a lower part and a connection member, suitable for releasably connecting panels together.

2. An apparatus or kit for according to claim 1, wherein the upper part has an upper surface and two side walls arranged substantially in parallel with one another and each substantially perpendicularly from the upper surface, and wherein the upper surface has a substantially circular aperture formed within it, and a substantially cylindrical wall extends downwards from the circular aperture substantially parallel to the two side walls, and wherein at least one stop is arranged within the cylindrical wall, the stop having an abutment surface for engagement with an abutment surface of a connection member.

3. An apparatus or kit according to claim 2, wherein there are four stops (110) approximately equally spaced around and within the cylindrical wall (108) with gaps between them, providing four abutment surfaces (110A) with gaps between them.

4. An apparatus or kit according to claim 2, wherein the upper part is provided with two or more stops, and wherein two stops are joined by a bridge (114) arranged between them, the bridge (114) having a further abutment surface (114A) arranged at an offset to the abutment surfaces (110A) of the stops (110) joined by the bridge.

5. An apparatus or kit according to any of claim 2, wherein one or more braces (122) extend between a side wall (104) and the cylindrical wall (108).

6. An apparatus or kit according to any of claim 2, wherein the cylindrical wall has regions of different internal diameter and at a transition between two regions of different internal diameter a lip is formed within the cylindrical wall.

7. An apparatus or kit according to claim 1, wherein the lower part (200) comprises a connection member engagement surface (252) having an opening (254) adapted to allow a lower end (306) of the connection member (300) to pass through the opening (254) when the connection member (300) is in a particular rotational orientation and to engage with the lower end (306) of the connection member when the connection member is in another particular rotational orientation.

8. An apparatus or kit according to claim 7, wherein the connection member engagement surface (252) is arranged approximately parallel to the lower surface (202) of the lower part (200) near or at an upper end of the side walls (204) of the lower part (200).

9. An apparatus or kit according to claim 7, wherein the opening of the connection member engagement surface (252) of the lower part has an approximately circular shape with at least one wider portion adapted to allow passage of a wing portion (308) of the connection member.

10. An apparatus or kit according to any of claim 7, wherein the connection member engagement surface of the lower part is provided on a removable insert (250).

11. An apparatus or kit according to claim 1, wherein the connection member comprises a substantially cylindrical shaft having a main shaft portion (302), an upper end (304) and a lower end (306), and wherein the upper end is of larger diameter than the main shaft portion (302), and wherein the lower end is of the same diameter as the main shaft portion and comprises at least one wing portion, the wing portion extending radially from the lower end of the shaft and having an abutment surface (310) for engagement with an abutment surface of a stop of the upper part, and wherein the connection member comprises a helical spring wound around the shaft, the spring being held in place by the upper end of the connection member and the or each wing portion.

12. An apparatus or kit according to claim 11, wherein the connection member has two wing portions (308) which extend radially in substantially opposite directions from each other.

13. An apparatus or kit according to claim 11, wherein the main shaft portion of the connection member is long enough so that the one or more wing portions can engage with a corresponding connection member engagement surface (252) of the lower part and exert an abutment force thereon.

14. An apparatus or kit for releasably connecting panels together according to claim 1, wherein:
the upper part has an upper surface and two side walls arranged substantially in parallel with one another and each substantially perpendicularly from the upper surface, and wherein the upper surface has a substantially circular aperture formed within it, and a substantially cylindrical wall extends downwards from the circular aperture substantially parallel to the two side walls, and wherein at least one stop is arranged within the cylindrical wall, the stop having an abutment surface for engagement with an abutment surface of a connection member;
the lower part comprises a connection member engagement surface having an opening adapted to allow a lower end of the connection member to pass through the opening when the connection member is in a particular rotational orientation and to engage with the lower end of the connection member when the connection member is in another particular rotational orientation; and
the connection member comprises a substantially cylindrical shaft having a main shaft portion, an upper end and a lower end, and wherein the upper end is of larger diameter than the main shaft portion, and wherein the lower end is of the same diameter as the main shaft and comprises at least one wing portion, the wing portion extending radially from the lower end of the shaft and having an abutment surface for engagement with an abutment surface of a stop of the upper part, and wherein the connection member comprises a helical spring wound around the shaft, the spring (312) being held in place by the upper end of the connection member and the or each wing portion.
